(19) United States
(12) Patent Application Publication
(10) Pub. No.: US 2016/0315997 A1
(43) Pub. Date: Oct. 27, 2016

(54) FILE TRANSFER METHOD, DEVICE, AND SYSTEM

(71) Applicant: BEIJING QIHOO TECHNOLOGY COMPANY LIMITED, Beijing (CN)

(72) Inventors: Huaqiang ZHAO, Beijing (CN); Lin WANG, Beijing (CN); Jiang XIAO, Beijing (CN); Pengfei WANG, Beijing (CN)

(21) Appl. No.: 15/103,734

(22) PCT Filed: Dec. 11, 2014
(86) PCT No.: PCT/CN2014/093577

§ 371 Date: Jun. 10, 2016

(30) Foreign Application Priority Data
Dec. 12, 2013 (CN) 201310681921.4
Dec. 12, 2013 (CN) 201310684043.1

(51) Int. Cl. H04L 29/08; H04L 29/06; H04L 9/06

(52) U.S. Cl. CPC H04L 67/06; H04L 67/1095; H04L 9/0643; H04L 63/0428

(57) ABSTRACT

Disclosed is a file transfer device, which runs on a computing device, and is configured to transfer a file on the computing device to a server and browse and/or download a file stored on the server. The file transfer device comprises: an upload controller, configured to transfer a local file of the computing device to the server and generate a corresponding file transfer record; and a download controller, configured to receive a download request for downloading data from the server, and determine, according to the file transfer record generated by the upload controller, whether the data in the download request is associated with the local file of the computing device, and if yes, acquire the data from the local file of the computing device, or if not, download the data from the server. Also disclosed are a corresponding file transfer method and corresponding network storage system.

### CROSS-REFERENCE TO RELATED APPLICATIONS

This application is the national stage of International Application No. PCT/CN2014/093577 filed Dec. 11, 2014, which is based upon and claims priority to Chinese Patent Applications No. CN201310684043.1 and CN201310681921.4, both filed Dec. 12, 2013, the entire contents of which are incorporated herein by reference.

### FIELD OF TECHNOLOGY

The present disclosure relates to computer and Internet area and, more particularly to a data synchronism technology.

### BACKGROUND

With the popularizing of Internet and computer, people may own several computer-applicants in their life and work generally, for example, at the work unit they use one set of computer at least, and at home may use another set, while going out or entertaining use various mobile computer-applicants, such as tablet computers or intelligent mobile phones. In order to manage the files in these computer-applicants in a unified way, network storage system appears.

A typical network storage system may include one storage server and a plurality of computing terminals. Each computing terminal communicates through network with the storage server. The computing terminal may transfer local files into the server as to be stored together collectively. While using other computing terminals, the user may browse the files stored in the server by these computing terminals, and may download these files into the local computing terminals for his/her usage. When network speed gets faster and more, this kind of network storage way is certainly welcomed by users.

However, within the network storage mode, every time a user searches and reads a file by his/her computer-terminal, if the file has not been cached in the terminal, (for instance, the computing terminal obtained the file and cached), thus each time the content of the file need to be got from the server. With the development of media content digitalizing, as well as with the resolution of multi-media contents getting higher and higher, and the content of file larger and larger, the time and network flow volume expended with the server for downloading these data longer and bigger, the user needs more and more time to wait for searching for and reading/looking at the files. Therefore, it is urgent to find a new way to transfer files from the server so as to heighten the efficiency of server's downloading data, and improve the user's experience and network utilization.

### SUMMARY

In the view of above problems, the disclosure is proposed to provide a technical solution in order to solve or at least relieve the problems above.

According to one aspect of the disclosure, there is provided a file transfer device, running on a computing device, and being configured to transfer a file on the computing device to a server and browse and/or download the file stored on the server, wherein the file transfer device comprises: an upload controller, configured to transfer the local file of the computing device to the server and generate a corresponding file transfer record; a download controller, configured to receive a download request for downloading data from the server, and determine whether the data in the download request is associated with the local file of the computing device according to the file transfer record generated by the upload controller, and if yes, obtain the data from the local file of the computing device, if not, download the data from the server.

According to another aspect of the disclosure, there is provided a file transfer method, running on a computing device, and being configured to transfer a file on the computing device to a server and browse and/or download a file stored on the server, wherein the file transfer method comprises: transferring the local file of the computing device to the server and generating a corresponding file transfer record; receiving a download request for downloading data from the server, and determining whether the data in the download request is associated with the local file of the computing device according to the generated file transfer record, and if yes, acquiring the data from the local file of the computing device, if not, downloading the data from the server.

According to another aspect of the disclosure, there is provided a computer program, includes computer readable codes, wherein when the computer readable codes run on a computer, it results in the computer executing the file transfer method stated above.

According to another aspect of the disclosure, there is provided a computer readable medium, wherein the computer program above is stored.

According to another aspect of the disclosure, there is provided a network storage system, comprising: a server and a plurality of computing devices, each computing device comprises a file transfer device above, in order to transfer the file on the computing device to the server, and browser the file on the server.

According to the file transfer technical solution of the embodiment of the disclosure, in a certain computing device, before downloading data from the server, firstly it is determined that the files related to the data is in other computing devices located in a same local network of the computing device. If yes, the data is obtained from the corresponding files of other computing devices, it is no need to send the request to the server. Therefore, the user's waiting time and data transfer quantity is greatly reduced, and the user's experience is improved while the network transmission is reduced.

According to another aspect of the disclosure, there is provided a file transfer device, running on a computing device, and is configured to transfer a file on the computing device to a server and browse and/or download a file stored on the server, wherein the file transfer device comprises: a nearby apparatus recognizer, configured to obtain at least one first other computing device which is in a same local network with the computing device; and a download controller, configured to receive a first download request for downloading data from the server, send the first download request to at least one first other computing device in the same local network, if any one of the first other computing device is capable to perform the first download request, download data from the first other computing device, or download data from the server.

According to another aspect of the disclosure, there is provided a file transfer method, running on a computing device, and being configured to transfer a file on the computing device to a server and browse and/or download a file stored on the server, wherein the file transfer method comprises: obtaining at least one first other computing device which is located in a same local network with the computing device from the server; receiving a first download request for downloading data from the server, and sending the first download request to at least one first other computing device in the same local network, if any first other computing device is capable to process the first download request, downloading the data from the first other computing device, or downloading the data from the server.

According to another aspect of the disclosure, there is provided a computer program, includes computer readable codes, wherein when the computer readable codes run on a computer, it results in the computer executing the file transfer method stated above.

According to another aspect of the disclosure, there is provided a computer readable medium, wherein the computer program above is stored.

According to another aspect of the disclosure, there is provided a network storage system, comprising: a server; and a plurality of computing device, each computing device comprises a file transfer device above, in order to upload the computing device to the server, and download data associated with the file from the server/other computing devices.

According to the file transfer technical solution of the embodiment of the disclosure, in a certain computing device, before downloading data from the server, firstly it is determined that the files related to the data is in uploaded to the server from the computing device. If yes, the data is obtained from the corresponding files of other computing devices, it is no need to send the request to the server. Therefore, the user's waiting time and data transfer quantity is greatly reduced, and the user's experience is improved while the network transmission is reduced.

Described above is merely an overview of the inventive scheme. In order to more apparently understand the technical means of the disclosure to implement in accordance with the contents of specification, and to more readily understand above and other objectives, features and advantages of the disclosure, specific embodiments of the disclosure are provided hereinafter.

### BRIEF DESCRIPTION OF THE DRAWINGS

Through reading the detailed description of the following preferred embodiments, various other advantages and benefits will become apparent to an ordinary person skilled in the art. Accompanying drawings are merely included for the purpose of illustrating the preferred embodiments and should not be considered as limiting of the invention. Further, throughout the drawings, same elements are indicated by same reference numbers. In the drawings:

FIG. 1 schematically shows a network storage system according to an embodiment of the disclosure;

FIG. 2 schematically shows a file transfer device according to an embodiment of the disclosure;

FIG. 3 schematically shows a file transfer method according to an embodiment of the disclosure;

FIG. 4 schematically shows a network storage system according to an embodiment of the disclosure;

FIG. 5 schematically shows a file transfer device according to an embodiment of the disclosure;

FIG. 6 schematically shows a file transfer method according to an embodiment of the disclosure;

FIG. 7 schematically shows a block diagram of the server which is configured to execute the method according to the present disclosure; and

FIG. 8 schematically shows the storage unit which is configured to hold or carry the program codes according to the method of the present disclosure.

### DESCRIPTION OF THE EMBODIMENTS

Exemplary embodiments of the present disclosure will be described in detail with reference to the accompanying FIGS. hereinafter. Although the exemplary embodiments of the disclosure are illustrated in the accompanying FIGS., it should be understood that the disclosure may be embodied in many different forms and should not be construed as being limited to the embodiments set forth herein. Rather, these embodiments are provided so that this disclosure will be understood thoroughly and completely and will fully convey the scope of the disclosure to those skilled in the art.

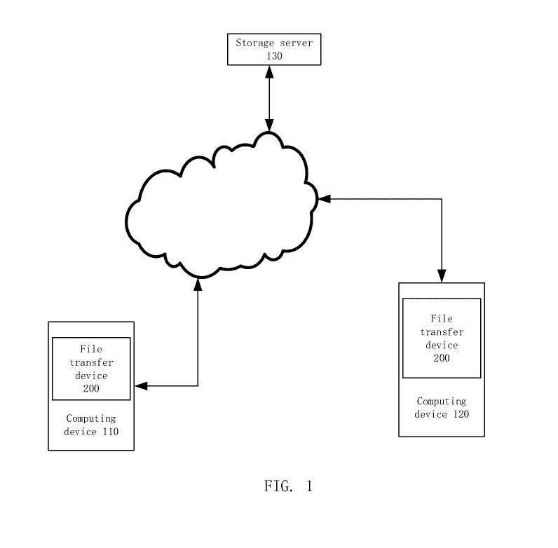

FIG. 1 schematically shows a network storage system according to an embodiment of the disclosure. As shown in FIG. 1, the network storage system 100 includes a storage server 130 and a plurality of computing devices 110 and 120 and so on. The computing devices 110 and 120 are connected to the storage server 130 via network. Each computing device may have a resident file transfer device 200. It is capable to transfer files in the computing device to the storage server 130 via the file transfer device 200, and it is also capable to browse and/or download file stored in the storage server 130 via the file transfer device 200. Thus, the storage server 130 provides a concentrated storage space. The user may use any one of the computing devices to view the files on the storage server 30. Besides, if the user thinks the file needs to be viewed in a plurality of computing devices, he or she may transfer the file to the storage server 130.

In the present disclosure, the computing devices 110 and 120 may be any devices for processing electronic data in the area, which may include but is not limited as a desktop computer, a notebook computer, a personal digital assistance, a smart mobile terminal, a tablet computer and so on. The computing devices 110 and 120 usually run modern operating systems. Hardware resources in the computing devices are managed by using the operating system. The computing devices 110 and 120 may run varieties of applications on the operating system. In the invention, the file transfer device 200 may be an application to run on the computing devices 110 and 120. Since the operating systems run on the computing devices are different, the ways of realizing the file transfer device 200 are different. The invention is not limited to certain realizations adopted for the file transfer device 200 to adapt to different operating systems, but is only limited to the necessary realization logic of the file transfer device 200 for realizing the function of the invention.

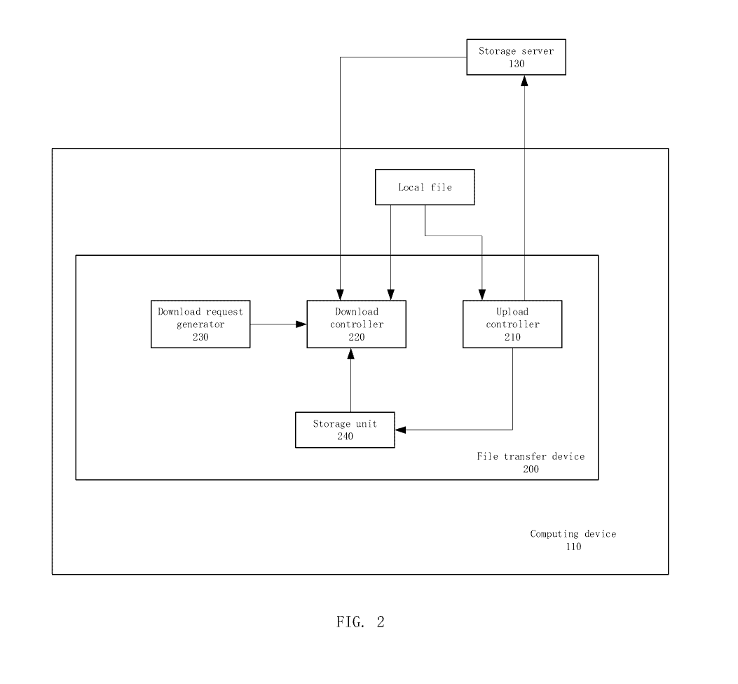

FIG. 2 schematically shows a file transfer device according to an embodiment of the disclosure. The file transfer device 200 is included in any of the computing devices 110 and 120, and is configured to run in the computing device, and is adapted to transfer the file on the computing devices to the storage server 130 and browse and/or download the files stored on the server 130.

As shown in FIG. 2, the file transfer device 200 includes an upload controller 210 and a download controller 220. The upload controller 210 uploads local file of the computing devices 110 and 120 to the storage server 130. The users of the computing devices 110 and 120 may need to transfer the file which is not finished in the office to the storage server 130 when he or she needs to transfer between the office and other places frequently, and then obtains the file when working at other places. In addition, as an example, the user may need to browser multi-media file on various mobile terminals. These multi-media files are originally stored in other desktop computers, at that moment, it is needed to use the upload controller 210 of the desktop computer to transfer the multi-media files to the storage server.

At the same time when the upload controller 210 transfers files to the storage server 130, it generates a corresponding file transfer record. Each time the upload controller 210 uploads a file, it generates a file transfer record. Each file transfer record may include a time of transferring the file, a local storage position of the file stored on the computing device, and the storage position of the file stored on the storage server 130. Selectively, the file transfer device 200 may also include a storage unit 240, used for storing the file transfer record generated by the upload controller 210.

The user may run the file transfer device 200 on the computing devices 110 and 120 to browse the files stored in the storage server 130. At that moment, the file transfer device 200 may obtain corresponding file storage structure (such as the menu structure, the file list of certain menu, and so on) from the storage server 130 and present to the user. The user may select certain file and download the file to view. In an example, when the user browses a graphics file under the menu of the server file, and when the user browses the file menu, the file transfer device 200 may present a thumbnails view. In another example, when the user needs to display a multi-media file on a certain server, the file transfer device 200 may request the multimedia data which is suitable for the computing device after cutting from the server. In the above examples, what the file transfer device 200 requests to download from the server is not the data of file itself, instead, it is the data generated according to the file content.

Therefore, selectively, the file transfer device 200 includes a download request generator 230. The download request generator 230 generates a download request which is to download data from the server according to the user's operation. The data that the download request requests to download is associated with the file stored on the server, for example, the data may be the data of the file itself, or data generated according to the file. The download request usually further includes a storage position of the related file on the server, therefore, the server 130 may accurately process the download request.

The download controller 220 is coupled to the download request generator 230 to receive the generated download request to process. The download controller 220 processes the download request according to the file transfer record generated by the upload controller 210. When the requested data in the download request may be obtained from the local file of the computing device according to the file transfer record (that is associated with the local file), the download controller 220 directly obtains data from the local file of the computing device. Otherwise, the download controller 220 sends the download request to the server 130 to obtain data from the server 130.

Selectively, when the data requested by the download request is the whole file, the download controller 220 generates a file transfer record while it finishes the download request of downloading file to local. Each file transfer record may include a time of transferring the file, a local storage position of the file stored on the computing device, and the storage position of the file on the storage server 130 and so on. Therefore, when the user requests to download the file which is the same as the file on the server once again, it may also directly obtain file from the local instead of downloading from the server according to the file transfer record. Since the user may download a file on the server for several times and respectively stores the files in different positions of the local device, as a result, there may be a plurality of file transfer records whose storage positions on the storage server are the same but the local storage positions are different.

In an embodiment of the disclosure, the download request includes a file storage position of a file in associated with the data in the download request on the server 130. Each file transfer record also includes a local storage position of the file on the computing device and the corresponding storage position on the server 130. The download controller 220 may search in the file transfer record list, in order to search the file transfer record in which the storage position on the server matches the file storage position in the download request. If corresponding record can be found, it is capable to consider that the download request may be satisfied by local files. Otherwise, the download request is sent to the server 130 in order to allow the server 130 to process the download request.

Furthermore, since the user may obtain the file via other computing devices from the server and then edit the file to upload after the file is transferred to the server, the locally stored file of the computing device may not be the latest file, as a result, the download controller 220 needs to further determine whether the locally stored file is consistent with the file stored on the server 130. In an embodiment, when the download controller 220 searches corresponding record in the file transfer record, it obtains the file information of the file which is in the corresponding storage position on the server from the server 130, compare the file information with the file information of the file in the local storage position in order to determine whether the locally stored file is consistent with the file stored on the server. If they are consistent, the local file is used to satisfy the download request, otherwise the download request is sent to the server 130, and is processed by the server 130. It should be noted that, since there may be a plurality of file transfer records whose storage positions on the storage server are the same but the local storage position are different, in searching in the file transfer record list, when it is found that the transferring record does not meet the requirement, it is required to continue searching in the list.

The file information may include the latest modify time of the file, the file size and/or MD5 value or hash value which is obtained by performing hashing calculated on the file content. The invention is not limited to be the specific content of the file information, on the contrary, all the content that may be used to determine whether the local file and the corresponding file on the server are consistent are in the scope of the invention.

In addition, selectively, since calculating hash value of the file consumes too much calculating time of the server and the computing device, the download controller 220 may firstly detect whether the latest modify time and size match each other, only when they match with each other, it performs hash value calculating and matching. Otherwise, it is capable to determine the local file is not consistent with the file on the server, and it is not needed to compare the hash value.

According to the file transfer device 200, it is capable to determine whether the file associated with the data in the download request is uploaded from the computing device to the server before downloading data from the server. If yes, it is capable to obtain data from the corresponding file of the computing device, rather than sending the request to the server, this may greatly reduce the user's waiting time and data transmission, and improves the user's experience and reduces the network transmission.

For example, the user has a mobile terminal (corresponding to the computing device 110), when the user uses the mobile terminal at home, he or she finds a piece of good music on the website, then or downloads the music to the mobile terminal and stored as a.mp3. The user then uploads the file to the “music” menu of the mobile terminal, then the upload controller 210 on the file transfer device 200 may generate a file transfer record, the recorded content includes file transfer time, local menu and position “a.mp3” and the storage position on the server “music/a.mp3”. After some time, the user forgets there is “a.mp3” stored in local, but the user uses the mobile terminal to browse the files on the server, and finds the music file a.mp3, and wants to listen to the music. Then the user may directly click the file to perform online display, at that moment, the download request generator 230 may generate the download request to request a.mp3 data, and when the download controller 220 receives the request, it may search in the file transfer record, and finds a.mp3 file has been stored in the mobile terminal locally. Then the download controller 220 may directly reads the local a.mp3 file to display, thus avoiding unnecessary network transmission, and reduces the time that the user waits for displaying music, as well as improving the user experience.

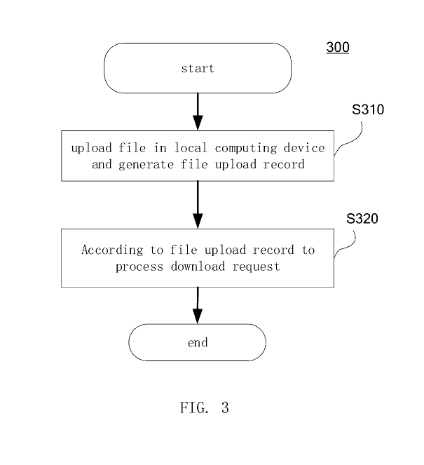

FIG. 3 schematically shows a file transfer method 300 according to an embodiment of the disclosure; the file transfer method 300 in FIG. 3 is adapted to be executed in the computing devices 110 and 120, in order to transfer file in the computing device to the server 130, and browse and/or download the file stored in the server 130. According to an embodiment, the file transfer method 300 may be executed by the file transfer device 200 in FIG. 2.

The file transfer method 300 starts at step S310, wherein the local file of the computing device is transferred to the storage server 130. The users of the computing devices 110 and 120 may need to transfer the file which is not finished in the office to the storage server 130 when he or she needs to transfer between the office and other places frequently, and then obtains the file when working at other places. In another example, the user may need to browser multi-media files on varieties of mobile terminals. These multi-media files are originally stored in other desktop computers, at that moment, it is needed to upload these multi-media files to the storage server by the desktop computer.

In step S310, at the same time when the file is transferred to the storage server 130, it generates a corresponding file transfer record. Each time a file is uploaded, a file transfer record is generated. Each file transfer record may include a time of transferring the file, a local storage position of the file stored on the computing device, and the storage position of the file on the storage server 130. Selectively, in step S310, the generated file transfer record is also stored.

The user may browse the files stored on the storage server 130 on the computing devices 110 and 120. At that moment, the computing device may obtain corresponding file storage structure (such as the menu structure, the file list of certain menu, and so on) from the storage server 130 and present to the user. The user may select certain file and download the file to view. In an example, when the user browses a graphics file under the menu of the server file, when the user browses the file menu, the computing device may present a thumbnails view. In another example, when the user needs to display a multi-media file on a certain server, the computing device may request the multimedia data which is suitable for the computing device after cutting from the server. In the above examples, what the computing device requests to download from the server is not the data of file itself, instead, it is the data generated according to the file content.

Therefore, in the computing device, it may generates a download request which is to download data from the server according to the user's operation. The data that the download request requests to download is associated with the file stored on the server, for example, the data may be the data of the file itself, or the data generated according to the file. The download request usually further includes a storage position of the related file on the server, therefore, the server 130 may accurately process the download request.

Then, in step S320, processing the generated download request. In step S320, the download request is processed according to the file transfer record generated in step S310, When the requested data in the download request may be obtained from the local file of the computing device according to the file transfer record (that is associated with the local file), in step S320, it is capable to directly obtain data from the local file of the computing device. Otherwise, the download request is sent to the server 130 to obtain data from the server 130.

Selectively, when the data requested by the download request is the whole file, in step S320, a file transfer record is generated while the download request is downloaded to local. Each file transfer record may include a time of transferring the file, a local storage position of the file stored on the computing device, and the storage position on the storage server 130 and so on. Therefore, when the user requests to download a file that is the same as in the server once again, it may also directly obtain file from the local instead of downloading from the server according to the file transfer record. Since the user may download a file on the server for several times and respectively stores the files in different positions of the local device, there may be a plurality of file transfer records whose storage positions of the storage server are the same but the local storage positions are different.

In an embodiment of the disclosure, the download request includes a file storage position of a file in associated with the file in the download request on the server 130. Each file transfer record also includes a local storage position of the computing device and the corresponding storage position on the server 130. In step S320, it is capable to search in the file transfer record list, in order to search the file transfer record in which the storage position on the server matches the file storage position in the download request. If corresponding record can be found, it is capable to consider that the download request may be satisfied by local files. Otherwise, the download request is sent to the server 130 in order to allow the server 130 to process the download request.

Furthermore, since the user may obtain the file via other computing devices from the server and then edit the file to upload after the file is transferred to the server, the locally stored file of the computing device may not be the latest file, as a result, in step S320, it is needed to further determine whether the locally stored file is consistent with the file stored on the server 130. In an example, when corresponding record is found in the file transfer record, it is capable to obtain the file information of the file which is in the corresponding storage position on the server from the server 130, compare the file information with the file information of the file in the local storage position in order to determine whether the locally stored file is consistent with the file stored on the server. If they are consistent, the local file is used to satisfy the download request, otherwise the download request is sent to the server 130, and is processed by the server 130. It should be noted that, since there may be a plurality of file transfer records whose storage positions on the storage server are the same but the local storage positions are different, in searching in the file transfer record list, when it is found that the transferring record does not meet the requirement, it is required to continue searching in the list.

The file information may include the latest modify time of the file, the file size and/or MD5 value or hash value which is obtained by performing hashing calculated on the file content. The invention is not limited to be the specific content of the file information, on the contrary, all the content that may be used to determine whether the local file and the corresponding file on the server are consistent are in the scope of the invention.

In addition, selectively, since calculating hash value of the file consumes too much calculating time of the server and the computing device, in step S320, it is capable to firstly detect whether the latest modify time and size match each other, only when they match with each other, it performs hash value calculating and matching. Otherwise, it is capable to determine the local file is not consistent with the file on the server, and it is not needed to compare the hash value.

According to the file transfer method 300, it is capable to determine whether the file associated with the data in the download request is uploaded from the computing device to the server before downloading data from the server. If yes, it is capable to obtain data from the corresponding file of the computing device, rather than sending the request to the server, this may greatly reduce the user's waiting time and data transmission, and improves the user's experience and reduces the network transmission.

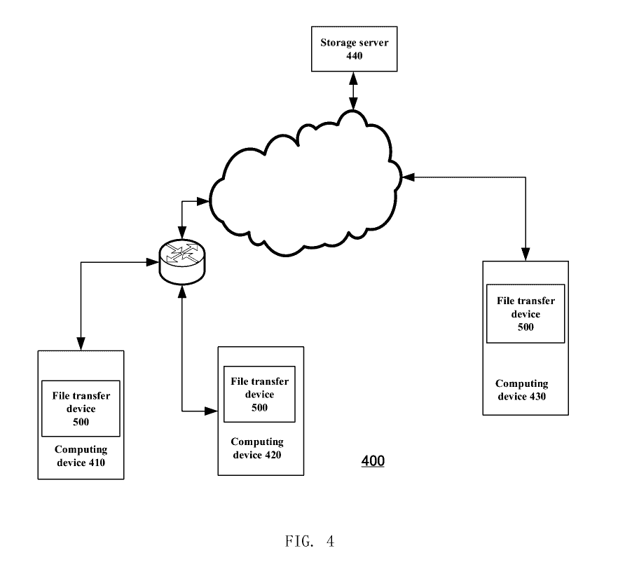

FIG. 4 schematically shows a network storage system 400 according to an embodiment of the disclosure; as shown in FIG. 4, the network storage system 400 includes a storage server 440 and a plurality of computing devices 410 to 430. The computing devices 410 to 430 are connected to the storage server 440 via network. The computing devices 410 and 420 are located in the same local network. With the development of Internet, in a home, it is common that there is a smart mobile terminal with strong calculation performance except for the traditional computer. They may access to the Internet via home local network, and may communicate with the storage server 440. Each computing device may include a file transfer device 500, and may browse and/or download the files stored in the storage server 440 via the file transfer device 500, and may also upload the files on the computing device to the storage server 440. Thus, the storage server 440 provides a concentrated storage space. The user may use any one of the computing devices to view the files on the storage server 440. Besides, if the user thinks the file needs to be viewed in a plurality of computing devices, he or she may transfer the file to the storage server 440.

In the present disclosure, the computing devices 410 and 430 may be any devices for processing electronic data in the area, which may include but is not limited as a desktop computer, a notebook computer, a personal digital assistance, a smart mobile terminal, a tablet computer and so on. The computing devices 410 and 430 usually run modern operating systems. Hardware resources in the computing device are managed by using the operating system. The computing device 410 and 430 may run various applications on the operating system. In the invention, the file transfer device 500 may be an application to be run on the computing devices 410 and 430. Since the operating systems run on the computing devices are different, the ways of realizing the file transfer device 500 are different. The invention is not limited to certain realizations adopted for the file transfer device 500 to adapt to different operating systems, but is only limited to the necessary realization logic of the file transfer device 500 for realizing the function of the invention.

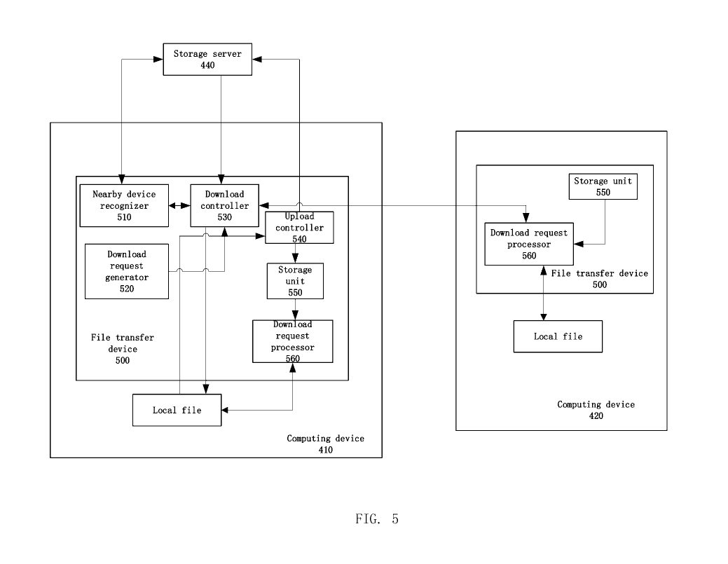

FIG. 5 schematically shows a file transfer device according to an embodiment of the disclosure. The file transfer device 500 is included in any of the computing devices 410 and 430 in FIG. 4, and is configured to run in the computing device, and is adapted to transfer the file on the computing devices to the storage server 440 and browse and/or download the files stored on the server 440.

As shown in FIG. 5, the file transfer device 500 includes a nearby apparatus recognizer 510, the nearby apparatus recognizer 510 is used to search the other computing devices in the same local network as the computing device which is resident together with the file transfer device 500 (in the following part, the file transfer device 500 shown in FIG. 2 which is resident in the computing device 410 of FIG. 1 is taken as an example for illustration, but it should be noted the above illustration is only schematic, rather than to limit the invention).

The nearby apparatus recognizer 510 may use various way to search other computing devices in a same local network. For example, the nearby apparatus recognizer 410 may use UDP protocol to broadcast in the local network, and other computing devices with the same nearby apparatus recognizer may answer the broadcast, thereby establishing communication and recognize each other.

According to an implementing way of the invention, the nearby apparatus recognizer 510 may communicate with the storage server 440. When the storage server 440 communicates with each computing devices 410 to 430, it obtains the information about which Internet IP address does each of the computing devices 410 to 440 uses to connect to the storage server 440. Since different computing devices in the same local network may access the Internet via a same IP address, when the storage server 440 finds a plurality of computing devices (such as the computing devices 410 and 420) accesses the storage server 440 via a same IP address, it may be considered that the computing devices are located in the same local network. Then, the storage server 440 may interact with the computing devices to obtain the IP address of the computing device in the local network (this may be achieved by sending instruction to the computing device, in order to allow the computing device to send the IP address in the local network to the server 440, but the invention is not limited thereto, all the ways of obtaining the IP address of the local network of the computing devices are in the scope of the invention). The storage server 440 sends the obtained IP address of the local network of the computing device to the nearby apparatus recognizers 510 of other computing devices, to allow the nearby apparatus recognizer 510 to know the one or more computing devices in the same local network of the computing device 410.

The user may run the file transfer device 500 on the computing devices 410 to browse the files stored in the storage server 440. At that moment, the file transfer device 500 may obtain corresponding file storage structure (such as the menu structure, the file list of certain menu, and so on) from the storage server 440 and present to the user. The user may select certain file and download the file to view. In an example, when the user browses a graphics file under the menu of the server file, when the user browses the file menu, the file transfer device 500 may present a thumbnails view. In another example, when the user needs to display a multi-media file on a certain server, the file transfer device 500 may request the multimedia data which is suitable for the computing device after cutting from the server. In the above examples, what the file transfer device 500 requests to download from the storage server 440 is not the data of file itself, instead, it is the data generated according to the file content.

Therefore, selectively, the file transfer device 500 includes a download request generator 520. The download request generator 520 generates a download request which is to download data from the storage server according to the user's operation. The data that the download request requests to download is associated with the file stored on the server, for example, the data may be the data of the file itself, or the data generated according to the file. The download request usually further includes a storage position of the associated file on the server, therefore, the server 440 may accurately process the download request.

As shown in FIG. 5, the file transfer device 500 includes a download controller 530. The download controller 530 is coupled to the download request generator 520 to receive the generated download request to process. The download controller 530 may obtain the information of other computing devices (computing device 420) which are in the same local network with the computing device 410 from the nearby apparatus recognizer 510, if other computing devices do not exist, the download controller 530 may send the download request to every other computing device to process. If any of the other computing device returns the message to show not capable to process the download request, the download controller 530 may send the download request to the server 440 to download the data. If any other computing device may process the download request, the download controller 530 may download data from the other computing devices.

Selectively, when the nearby apparatus recognizer 510 obtains a plurality of other computing devices, and if there are more than one computing devices which may process the download controller 530, it is capable to use ways similar as peer-to-peer network transmission to download the data. That is, the download controller 530 may divide the download request to a plurality of download requests, each download request is used to download a part of data which is originally intended to download, and the download requests are sent to another computing device respectively to obtain the corresponding data. Afterwards, the download controller 530 combines the obtained data to finish the process to the original download request.

Besides browsing and/or downloading the storage server 440, the file transfer device 500 is further used to upload the local file of the computing device 410 to the storage server 440. Therefore, the file transfer device 500 includes an upload controller 540. The upload controller 540 uploads the local file of the computing device 410 to the storage server 440. The user may need to transfer the file which is not finished in the office to the storage server 440 when he or she needs to transfer between the office and other places frequently, and then obtains the file when working at other places. In addition, as an example, the user may need to browser multi-media files on various mobile terminals. These multi-media files are originally stored in other desktop computers, at that moment, it is needed to use the upload controller 540 of the desktop computer to transfer the multi-media file to the storage server.

At the same time when the upload controller 540 transfers files to the storage server 440, it generates a corresponding file upload record. Each time the upload controller 540 uploads a file, it generates a file upload record. Each file upload record may include a time of transferring the file, a local storage position of the file stored on the computing device, and the storage position on the storage server 440. Selectively, the file transfer device 500 may also include a storage unit 550, used for storing the file upload record generated by the upload controller 540.

In order to process the download request from other computing devices in a same local network, the file transfer device 500 may further include a download request processor 560. The download request processor 560 receives the download request from other computing devices and processes it. The download request processor 560 determines whether the data in the download request is associated with the local file of the computing device according to the generated file upload record. If associated, it returns a message about the download request is capable to be processed to the computing device which sends request, and then obtains data from the local file of the computing device and return to other computing devices. If not associated, the download request processor 560 returns message about being not capable to process the download request.

In an embodiment, the download request includes a file storage position of the file in associated with the data in the download request on the server 440, each file upload record includes a local storage position of the file on the computing device and the corresponding storage position of the file on the server 440. The download request processor 560 may be searched in the file upload record list, to search the file upload record of the storage position of the file on the server matching the file storage position of the download request. If the corresponding record can be found, it may be consider that the download request may be satisfied by local file, otherwise returning a message about being not capable to process the download request.

Furthermore, after the file is uploaded to the server, the user may obtain the file from the server by other computing devices and then edit the file and upload again. Thusly the stored file in the local computing device may not be the latest. As a result, the download request processor 560 may need to further determine whether the locally stored file is consistent with the file stored on the server 440. In an example, when the download request processor 560 finds corresponding record in the file transfer record, it is capable to obtain the file information of the file which is in the corresponding storage position on the server from the server 440, compare the file information with the file information of the file in the local storage position in order to determine whether the locally stored file is consistent with the file stored on the server. If they are consistent, the local file is used to satisfy the download request, otherwise it returns a message about being not capable to process the download request.

The file information may include the latest modify time of the file, the file size and/or MD5 value or hash value which is obtained by performing hashing calculated on the file content. The invention is not limited to be the specific content of the file information, on the contrary, all the content that may be used to determine whether the local file and the corresponding file on the server are consistent are in the scope of the invention.

In addition, selectively, since calculating hash value of the file consumes too much calculating time of the server and the computing device, the download request processor 560 may firstly detect whether the latest modify time and size match each other, only when they match with each other, it performs hash value calculating and matching. Otherwise, it is capable to determine the local file is not consistent with the file on the server, and it is not needed to compare the hash value.

According to the file transfer device 500, it is capable to determine whether the file associated with the data is on other computing devices in the same local network with the computing device before downloading from the server. If yes, it is capable to obtain data from the corresponding file of the computing device, rather than sending the request to the server, this may greatly reduce the user's waiting time and data transmission, and improves the user's experience and reduces the network transmission.

For example, the user has a mobile terminal (corresponding to computing device 410) and a notebook computer (corresponding to computing device 420) at home, these two devices access to internet by a same router. When the user uses the mobile terminal, he or she finds a piece of good music on the website, then downloads the music to the mobile terminal and stored as a.mp3. In order to share the file with the computer in the office (corresponding to the computing device 430), the user then uploads the file to the “music” menu of the storage server 440, then the upload controller 540 on the file transfer device 500 on the mobile terminal may generate a file transfer record, the recorded content includes file transfer time, local menu and position “a.mp3” and the storage position on the server “music/a.mp3”. After some time, the user browses the files on the server with notebook computer, and finds the music file a.mp3, and wants to listen to the music, then the user may directly click the file to perform online display, at that moment, in the notebook computer, the nearby apparatus recognizer 510 may recognize that the mobile terminal and the notebook computer are in a same local network, the download request generator 520 may generate a download request to request for downloading the a.mp3 data, and when the download controller 530 receives the requirement, it may firstly obtain other devices in the same local network from the computing device 410, that is the mobile terminal, and send the download request to the mobile terminal. The download request processor 560 in the mobile terminal searches in the file transfer record, and finds the a.mp3 file has been stored in local, thus the download request processor 560 may directly reads the data of the a.mp3 in the local mobile terminal and return to the download controller 530 of the notebook computer, thus avoiding unnecessary network transmission, and reduces the time that the user waits for displaying music, as well as improving the user experience.

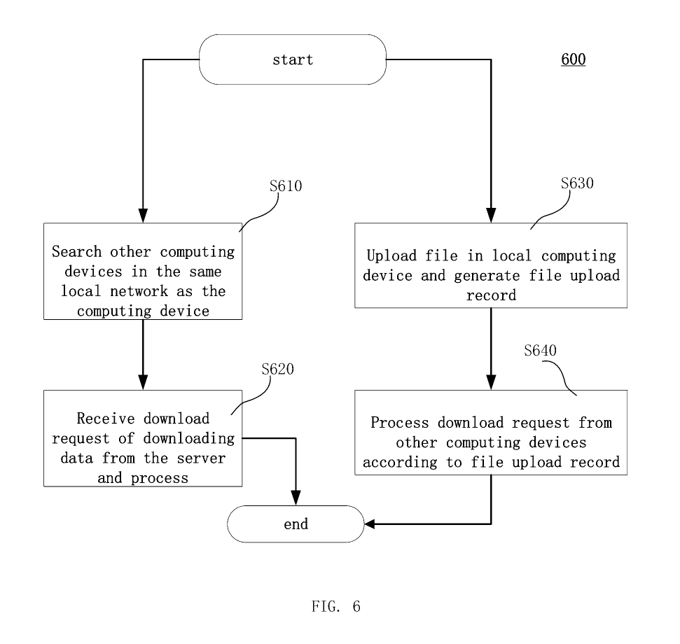

FIG. 6 schematically shows a file transfer method according to an embodiment of the disclosure; in FIG. 6, the file transfer method 600 is adapted to be executed in the computing devices 410 to 430 in FIG. 4, in order to upload the files in the computing device to the storage server 440, and browse and/or download the files stored in the storage server 440. According to an embodiment, the file transfer method 600 may be executed by the file transfer device 500 in FIG. 5.

The file transfer method 600 starts at step S610, in step S610, it is capable to find other computing devices in the same local network with the computing device for executing the file transfer method 600 (in the following part, the file transfer method 600 may be illustrated by the computing device 410 shown in FIG. 4 but it should be noted the above illustration is only schematic, rather than to limit the invention).

It is capable to search other computing devices in a same local network. For example, in a method, it is capable to use UDP protocol to broadcast in the local network, and other computing devices with the same nearby apparatus recognizer may answer the broadcast, thereby establishing communication and recognize each other.

According to another implementing way of the invention, the computing device may communicate with the storage server 440 at fixed time. When the storage server 440 communicates with each computing devices 410 to 430, it obtains the information about which Internet IP address does each of the computing devices 410 to 440 use to connect to the storage server 440. Since different computing devices in the same local network may access the Internet via a same IP address, when the storage server 440 finds a plurality of computing devices (such as the computing devices 410 and 420) access the storage server 440 via a same IP address, it may be considered that the computing devices are located in the same local network. Then, the storage server 440 may interact with the computing devices to obtain the IP address of the computing device in the local network (this may be achieved by sending instruction to the computing device, in order to allow the computing device to send the IP address in the local network to the server 440, but the invention is not limited thereto, all the ways of obtaining the IP address of the local network of the computing devices are in the scope of the invention). The storage server 440 sends the obtained IP address of the local network of the computing device to other computing devices, to allow each computing device to know the one or more computing devices in the same local network of the computing device 410.

The user may browse the files stored in the storage server 440 via the computing devices 410. At that moment, the computing device 410 may obtain corresponding file storage structure (such as the menu structure, the file list of certain menu, and so on) from the storage server 440 and present to the user. The user may select certain file and download the file to view. In an example, when the user browses a graphics file under the menu of the server file, when the user browses the file menu, a thumbnails view may be presented. In another example, when the user needs to display a multi-media file on a certain server, the computing device may request the multimedia data which is suitable for the computing device after cutting from the server. In the above examples, what the computing device requests to download from the storage server is not the data of file itself, instead, it is the data generated according to the file content.

Therefore, selectively, the file transfer method includes step S620, which generates a download request which is to download data from the server according to the user's operation. The data that the download request requests to download is associated with the file stored on the server, for example, the data may be the data of the file itself, or the data generated according to the file. The download request usually further includes a storage position of the related file on the server, therefore, the server 440 may accurately process the download request. In step S620, it is capable to view whether information of other computing devices (computing device 120) in a same local network with the computing device 410 is obtained in step S610, if the computing device does not exist, in step S620, the download request may be sent to every other computing device to process. If every computing device returns the message to show not capable to process the download request, the download request may be sent to the server 440 to download the data. If any other computing device may process the download request, the download controller 530 may download data from the other computing devices.

Selectively, when a plurality of other computing devices are obtained in step S610, and if it is determined in step S620 that there are more than one computing devices which may process the download request, it is capable to use ways similar as peer-to-peer network transmission in step S620 to download the data. That is, the download request may be divided into a plurality of download requests, each download request is used to download a part of data which is originally intended to download, and the download requests are sent to another computing device respectively to obtain the corresponding data. Afterwards, in step S620, it is capable to combine the obtained data to finish the process to the original download request.

Besides browsing and/or downloading the storage server 440, the file transfer method 600 is further used to upload the local file of the computing device to the storage server 440. Therefore, the file transfer method 600 includes step S630. In step S630, the local file of the computing device 410 is uploaded to the storage server 440. The user may need to transfer the file which is not finished in the office to the storage server 440 when he or she needs to transfer between the office and other places frequently, and then obtains the file when working at other places. In addition, as an example, the user may need to browser multi-media files on various mobile terminals. These multi-media files are originally stored in other desktop computers, at that moment, it is needed to use the desktop computer to transfer the multi-media file to the storage server.

In step S630, at the same of uploading the file to the storage server 440, a corresponding file upload record is generated at the same time. Each time a file is uploaded, it generates a file upload record. Each file upload record may include a time of transferring the file, a storage position of the file stored on the local computing device, and the storage position on the storage server 440. Selectively, step S630 may also include the step of storing the generated file upload record.

In order to process the download request from other computing devices in a same local network, file transfer method 600 may further include step S640. In S640, it is capable to receive the download request from other computing devices and processes it. In step S640, whether the data in the download request is associated with the local file of the computing device is determined according to the file upload record generated in step S630. If associated, it returns a message about the download request is capable to be processed to the computing device which sends the request, and then obtains data from the local file of the computing device and returns to other computing devices. If not associated, the download request processor 560 returns message about being not capable to process the download request.

In another embodiment, the download request includes a file storage position of the file in associated with the data in the download request on the server 440, each file upload record includes a local storage position of the file on the computing device and the corresponding storage position of the file on the server 440. In step S640, it is capable to search in the file upload record list, to search the file upload record of the storage position of the file on the server matching the file storage position of the download request. If the corresponding record can be found, it may be considered that the download request may be satisfied by local file, otherwise returning a message about being not capable to process the download request.

Furthermore, after the file is uploaded to the server, the user may obtain the file from the server by other computing devices and then edit the file and upload again. Thusly the stored file in the local computing device may not be the latest. As a result, in step S640, it is needed to further determine whether the locally stored file is consistent with the file stored on the server 440. In an example, when corresponding record is found in the file upload record, it is capable to obtain the file information of the file which is in the corresponding storage position on the server from the server 440, compare the file information with the file information of the file in the local storage position in order to determine whether the locally stored file is consistent with the file stored on the server. If they are consistent, the local file is used to satisfy the download request, otherwise it is capable to return a message about being not capable to process the download request.

The file information may include the latest modify time of the file, the file size and/or MD5 value or hash value which is obtained by performing hashing calculated on the file content. The invention is not limited to be the specific content of the file information, on the contrary, all the content that may be used to determine whether the local file and the corresponding file on the server are consistent are in the scope of the invention.

In addition, selectively, since calculating hash value of the file consumes too much calculating time of the server and the computing device, in step S640, it may firstly detect whether the latest modify time and size match each other, only when they match with each other, it performs hash value calculating and matching. Otherwise, it is capable to determine the local file is not consistent with the file on the server, and it is not needed to compare the hash value.

According to the file transfer method 600, it is capable to determine whether the file associated with the data is on other computing devices in the same local network with the computing device before downloading from the server. If yes, it is capable to obtain data from the corresponding file of the computing device, rather than sending the request to the server, this may greatly reduce the user's waiting time and data transmission, and improves the user's experience and reduces the network transmission.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the apparatus of the client or server according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

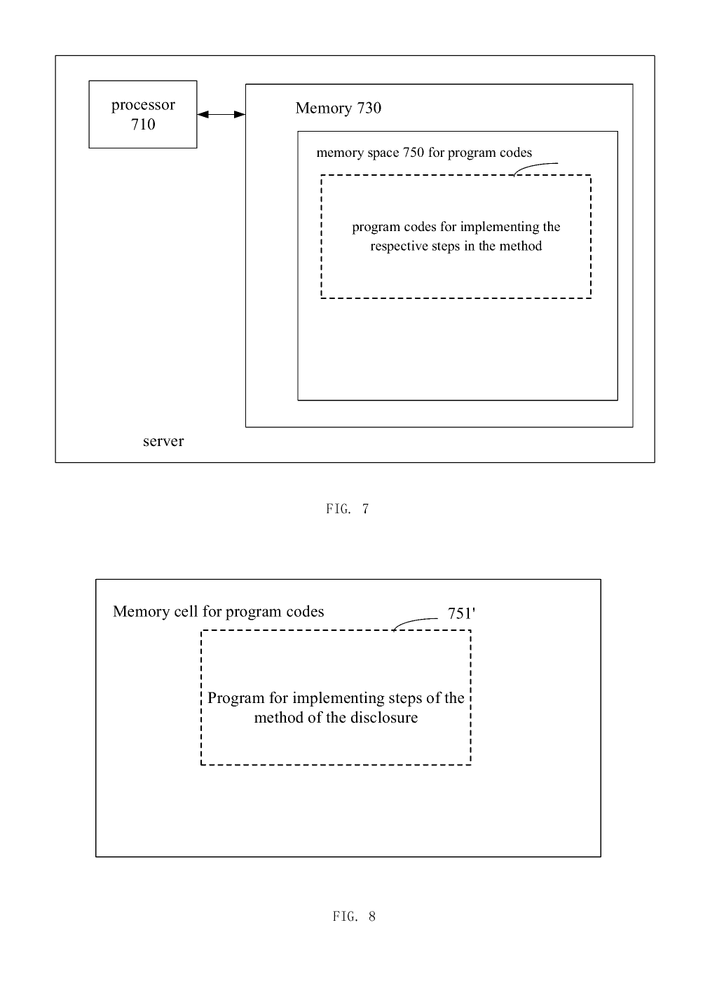

For example, FIG. 7 illustrates a block diagram of an electronic device for executing the method according the disclosure. Traditionally, the electronic device includes a processor 710 and a computer program product or a computer readable medium in form of a memory 730. The memory 730 could be electronic memories such as flash memory, EEPROM (Electrically Erasable Programmable Read-Only Memory), EPROM, hard disk or ROM. The memory 730 has a memory space 750 for executing program codes 751 of any steps in the above methods. For example, the memory space 750 for program codes may include respective program codes 751 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 8. The memory cells may be provided with memory sections, memory spaces, etc., similar to the memory 750 of the server as shown in FIG. 7. The program codes may be compressed for example in an appropriate form. Usually, the memory cell includes computer readable codes 751′ which can be read for example by processors 710. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed terminal device. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

1. A computing device, being configured to transfer a file on the computing device to a server and browse or download the file stored on the server, wherein the computing device comprises:
a memory having instructions stored thereon;
a processor configured to execute the instructions to perform operations, comprising:
transferring the local file of the computing device to the server and generate a corresponding file transfer record;
receiving a download request for downloading data from the server, and determining whether the data in the download request is associated with the local file of the computing device according to the file transfer record generated by the upload controller, and if yes, obtaining the data from the local file of the computing device, if not, downloading the data from the server.

2. The computing device according to claim 1, wherein the processor is further configured to perform:
generating the download request which downloads data from the server when the download request requests to download the file from the server.

3. The computing device according to claim 1, wherein the processor is further configured to perform:
generates the corresponding file transfer record when the download request requests to download file from the server.

4. The computing device according to claim 1, wherein the file transfer record comprises a storage position of file stored on the local computing device and a storage position of the file stored on the server.

5. The computing device according to claim 1, wherein whether the data in the download request is associated with the local file of the computing device comprises: determining whether the storage position of the file providing the data in the download request on the server is stored in the file transfer record.

6. The computing device according to claim 5, wherein the determining whether the data in the download request is associated with the local tile of the computing device comprises: obtaining file information of the file providing the data in the download request from the server, comparing the file information with the file information of the file in the local storage position in the file transfer record, if match, determining whether the data is associated with the local file of the computing device.

7. (canceled)

8. A file transfer method, running on a computing device, and being configured to transfer a file on the computing device to a server and browse or download a file stored on the server, wherein the file transfer method comprises:
transferring the local file of the computing device to the server and generating a corresponding file transfer record;
receiving a download request for downloading data from the server, and determining whether the data in the download request is associated with the local file of the computing device according to the generated file transfer record, and if yes, acquiring the data from the local file of the computing device, if not, downloading the data from the server.

9. The file transfer method according to claim 8, further comprising: generating a corresponding file transfer record when the download request requests to download the file from the server.

10. The file transfer method according to claim 8, wherein the file transfer record comprises a storage position of the file on the local computing device and a storage position of the file on the server.

11. The file transfer method according to claim 10, wherein whether the data in the download request is associated with the local file of the computing device comprises: determining whether the storage position of the file providing the data in the download request on the server matches the storage position on the server in the file transfer record.

12. The file transfer method according to claim 11, wherein the determining whether the data in the download request is associated with the local file of the computing device comprises: obtaining file information of the file providing the data in the download request from the server, comparing the file information with the file information of the file at the local storage position in the file transfer record, if match, determining whether the data is associated with the local file of the computing device.

13. The file transfer method according to claim 12, wherein the file information comprises a file modify time, a size and a hash value of a file content.

14.-16. (canceled)

17. A computing device, configured to transfer a file on the computing device to a server and browse or download a file stored on the server, wherein the computing device comprises:
a memory having instructions stored thereon;
a processor configured to execute the instructions to perform operations, comprising:
obtaining at least one first other computing
device which is in a same local network with the computing device; and
receiving a first download request for downloading data from the server, sending the first download request to at least one first other computing device in the same local network, if any one of the first other computing device is capable to perform the first download request, downloading data from the first other computing device, or download data from the server.

18. The computing device according to claim 17, wherein the processor is further configured to perform
uploading the local file of the local computing device to the server and generating corresponding file upload record; and
receiving a second download request from a second other computing device, determining whether the data in the second download request is associated with the local file of the computing device according to the file upload record generated by the upload controller, if yes, processing the second download request, obtaining data from the local file of the computing device and returning the obtained data to the second other computing device.

19. The computing device according to claim 17, wherein the processor is further configured to generate a first download request for downloading data from the server.

20. The computing device according to claim 18, wherein the file upload record comprises a file modify time, a size and a hash value of a file content.

21. The computing device according to claim 20, wherein determining whether the data in the second download request is associated with the local file of the computing device comprises: determining whether the storage position of the file associated with the data in the second download request on the server is included in the file upload record.

22. The computing device according to claim 21, wherein determining whether the data in the second download request is associated with the local file of the computing device comprises: obtaining the file information of the file associated with the data in the second download request from the server, comparing the file information with the file information of the file in the local storage position in the file upload record, if match, determining whether the data is associated with the local file of the computing device.

23. The computing device according to claim 22, wherein the file information comprises a file modify time, a size and a hash value of a file content.

24. The computing device according to claim 17, wherein the processor is further configured to perform:
if a plurality of first other computing devices are capable to process the first download request, separating the first download request to a plurality of third download requests, and each third download request is sent to a corresponding first other computing device, to obtain different parts of the data from a plurality of the first other computing devices.

25.-33. (canceled)
